(19) United States
(12) Patent Application Publication
(10) Pub. No.: US 2002/0092627 A1
(43) Pub. Date: Jul. 18, 2002

(54) Vertical blind murals

(76) Inventor: Marguerite C. Whitney, Bullhead City, AZ (US)

Correspondence Address: Marguerite C. Whitney, 192 Hacienda Loop, Bullhead City, AZ, 86429, US

(21) Appl. No.: 09/759,884

(22) Filed: Jan. 16, 2001

(51) Int. Cl. E06B 9/00

(52) U.S. Cl. 160/236

(57) ABSTRACT

The product produced from the Patent, would be the only “new” that I know of. It is a “do it yourself” way of bringing beauty into the average home. It eliminates Interior Decorators, that the average person cannot afford.

### SPECIFICATIONS

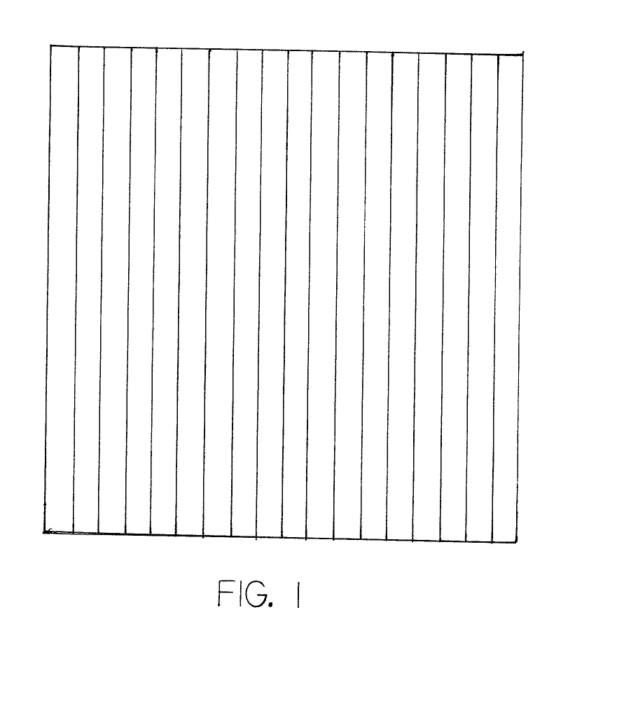

FIG. 1. A mural of various sizes, and of various scenes, such as, mountains, desert, seaside, well known works of art, a persons own favorite picture, after enlargement.

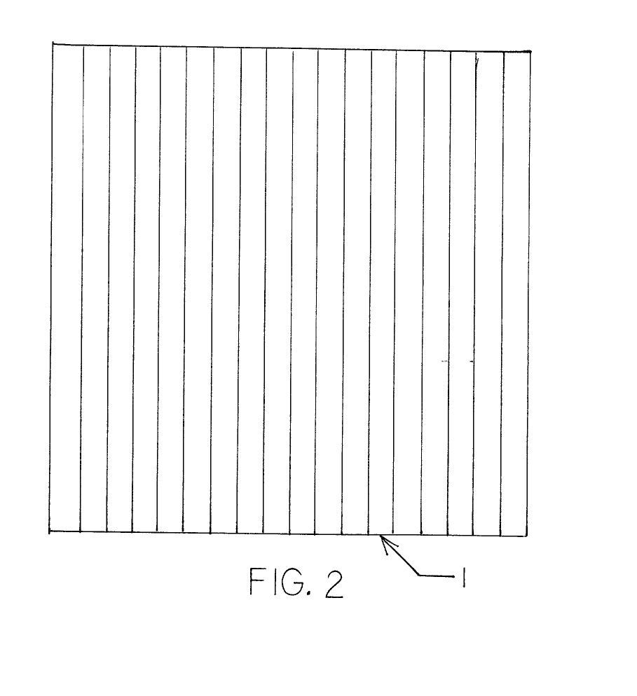

FIG. 2. Is the adhesive covering the back of the Mural. The adhesive is that what is used on postage stamps, labels and etc.

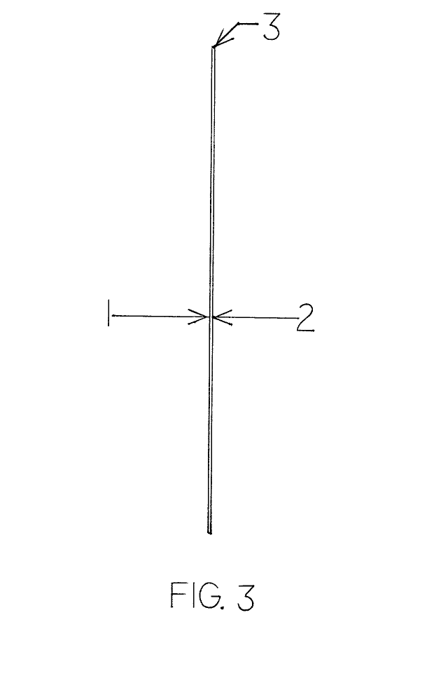

FIG. 3 Is a clear plastic that covers the adhesive. It contains the pattern for cutting and applying, and numbered in sequence, 3½″ vertical strips. Also, the instructions.

### BACKGROUND

1. U.S. Pat. No. 4,434,834 Mar. 6, 1984 “Inserts material between flanges” Flanges are plastic. They break easily and deteriorate.

2. U.S. Pat. No. 3,54,192 Jan. 10, 1995 Is a design on a vertical slat. It is “on” the slat.

3. U.S. Pat. No. 5,303,760 Apr. 19, 1994 “Fits over” the slat. Main objection is removing to clean. My way can be cleaned, on the slat with a solution on a cloth, while still on the vertical.

4. U.S. Pat. No. 4,911,220 Mar. 27, 1990 Same objections.

5. U.S. Pat. No. 4,884,615 Dec. 5, 1989 It's “sound reducing material” only.

6. U.S. Pat. No. 5,029,413 Jul. 9, 1991 Is “glass ornaments affixed to a vertical”.

U.S. Pat. No. 4,628,980 Dec. 16, 1986 Is a “transparent edging” for a vertical, called flanges.

U.S. Pat. No. 5,303,760 Apr. 19, 1994 “Detachable fits over existing vertical” Attached to the upper structure. States “scene” not scenes. This limits it to just one. Again, the problem of cleaning. It has to be removed from the vertical slat, and the upper holding attachment. Then cleaned, recovered, and re-installed to its support system. Number 6 is the only one that even comes close, and it is completely different.

### DETAILED DESCRIPTION

Since the description is so simple, a “detailed” would be the same as the “brief”. It is a “do it yourself” project that eliminates the need for an expensive Interior Decorator.

### BRIEF DESCRIPTION

FIG. 1. Front, which would be the Mural.

FIG. 2. Back, showing the pattern for the cutting pattern of 3½″, numbered in increments for easy application.

FIG. 3. Is the adhesive of Mural. Also, it holds the two pieces, the Mural and back pattern together until ready for use.

### SUMMARY

All of the exhibits in the Background pages, either do not have an artistic value, a definite problem of the cleaning, plastic flanges that break easily, and deteriorate rapidly, when inserts are used.

Another problem is, you have to use verticals with flanged sides, to use any of the decorative inserts mentioned, and I find the flanges to be a big problem. See the above reasons with inserts, it is, taking down, removing covering to clean, inserting again. The same is true of covers.

What I claim as my invention is:

1. A new and different way to bring art into the everyday home. It is a Mural with a “peel off” back held together by an adhesive, such as is used in postage stamp and labels. The backing would contain all of the instructions for cutting and applying the Mural to a vertical or any other surface desired. The original claim states “adhesive”, it does not use the pertinent word “glue”.
